(19) United States
(12) Patent Application Publication
(10) Pub. No.: US 2026/0204763 A1
(43) Pub. Date: Jul. 16, 2026

(54) HIGH POWER CIRCULAR TO RECTANGULAR WAVEGUIDE TRANSITION

(71) Applicant: VIETTEL GROUP, Ha Noi City (VN)

(72) Inventors: HAI QUAN HO, Ha Noi City (VN); THAI BINH NGUYEN, Ha Noi City (VN); LE HOANG LONG TAN, Ha Noi City (VN); QUANG HUY DONG, Ha Noi City (VN); DUY PHONG NGUYEN, Ha Noi City (VN)

(73) Assignee: VIETTEL GROUP, Ha Noi City (VN)

(21) Appl. No.: 19/433,740

(22) Filed: Dec. 27, 2025

(30) Foreign Application Priority Data
Dec. 27, 2024 (VN) 1-2024-09787

(51) Int. Cl. H01P 5/08

(52) U.S. Cl. CPC H01P 5/082; H01P 5/085

(57) ABSTRACT

A circular-to-rectangular waveguide transition for transmitting high-power radio frequency signals includes a circular flange (200), a rectangular flange (300), a circular waveguide (101), an elliptically shaped transition waveguide (102), a rectangular waveguide (103), and two impedance-matching iris bars (104).

### FIELD OF THE INVENTION

This patent relates to a high-power radio frequency (RF) waveguide transition from a circular waveguide into a rectangular waveguide. Specifically, the transition includes a circular waveguide and a rectangular waveguide connected to each other via a transition waveguide. The inner surface of the transition waveguide coincides with that of the rectangular waveguide at the contact plane. At the end connected plane to the circular waveguide, the transition waveguide has a hybrid elliptical cross-section with two parallel sides equal to the width of the rectangular waveguide, while the top and bottom sides are elliptically curved. Additionally, two metallic impedance-matching iris bars (hereinafter referred to as “iris”) are located inside the rectangular waveguide near the connection interface to match the impedance between the circular and rectangular waveguides.

### BACKGROUND OF THE INVENTION

High-power RF sources such as megawatt-class magnetrons commonly have circular waveguide outputs, operating in the dominant TE₁₁ mode. However, most high-power RF components, such as antennas or loads, use rectangular waveguides operating in the dominant TE₁₀ mode because they are more compact than circular waveguides at the same frequency band. Therefore, circular-to-rectangular waveguide transition are commonly used to connect RF sources with circular outputs to the loads with rectangular waveguide systems.

Conventional circular-to-rectangular transitions typically use a gradual taper, as illustrated in FIG. 1, where the waveguide cross-section is continuously transformed from circular to rectangular. For these circular-to-rectangular transitions, the gradual taper must have a length of at least twice the guide wavelength, denoted as λ_{g}. The guide wavelength corresponds to the wavelength at the center frequency within the operating frequency band.

For example, a circular-to-rectangular waveguide transition at 1.3 GHz usually requires a length of at least 2λ_{g}≈66 cm to ensure low return loss. Such a long taper section makes manufacturing complex, costly, and bulky, especially in high-power systems. Therefore, a compact, easy-to-manufacture, and cost-effective circular-to-rectangular waveguide transition could overcome these limitations.

### SUMMARY OF THE INVENTION

The first objective of this invention is to provide a compact, economical, and easily manufacturable high-power circular-to-rectangular waveguide transition. To achieve this, the invention employs an elliptically shaped transition waveguide that gradually transforms into a rectangular shape—one end connected to the circular waveguide and the other end to the rectangular waveguide.

The second objective is to achieve compactness while maintaining low reflection loss and high transmission efficiency. Instead of using a long transition section for gradual impedance matching, this invention introduces two impedance-matching irises inside the rectangular waveguide. These irises enable impedance matching between the circular and rectangular waveguides, allowing the transition waveguide length to be reduced up to eight times, from 2λ_{g} down to only ¼λ_{g}. This design not only reduces the transition size, but simplifies the machining and thereby lowers manufacturing costs.

### DESCRIPTION OF THE DRAWINGS

FIG. 1 Conventional circular-to-rectangular waveguide transition with gradual taper transition.

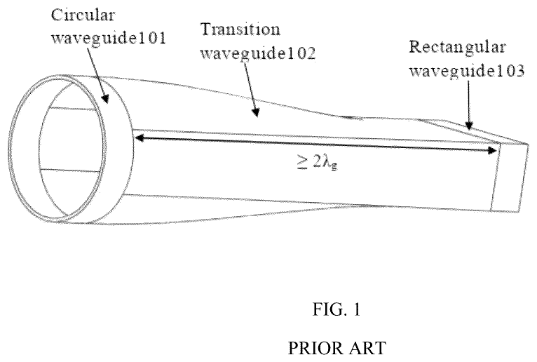

FIG. 2 Front view of the circular-to-rectangular waveguide transition as seen from the circular waveguide side.

FIG. 3 Front view of the circular-to-rectangular waveguide transition as seen from the rectangular waveguide side.

FIG. 4 Side sectional view of the circular-to-rectangular waveguide transition cut along plane BB in FIG. 2.

FIG. 5 Cross-sectional view of the circular-to-rectangular waveguide transition cut along plane AA in FIG. 2.

FIG. 6 Cross-sectional view of the circular-to-rectangular waveguide transition cut along plane BB in FIG. 2.

FIG. 7 Return loss characteristics of the circular-to-rectangular waveguide transition.

### DETAILED DESCRIPTION OF THE INVENTION

Referring to the accompanying drawings, which illustrate the embodiment of the invention without limiting its scope:

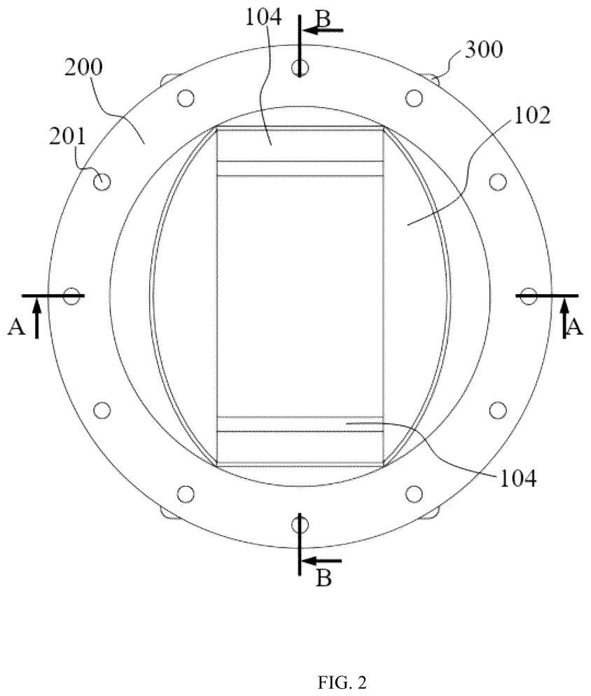

As shown in FIGS. 2-6 , the circular-to-rectangular waveguide transition includes a circular waveguide (101), a transition waveguide (102), and a rectangular waveguide (103). The inner diameter of the circular waveguide and the dimensions of the rectangular waveguide depend on the RF operating frequency band, with the circular cross-section area being larger than that of the rectangular waveguide.

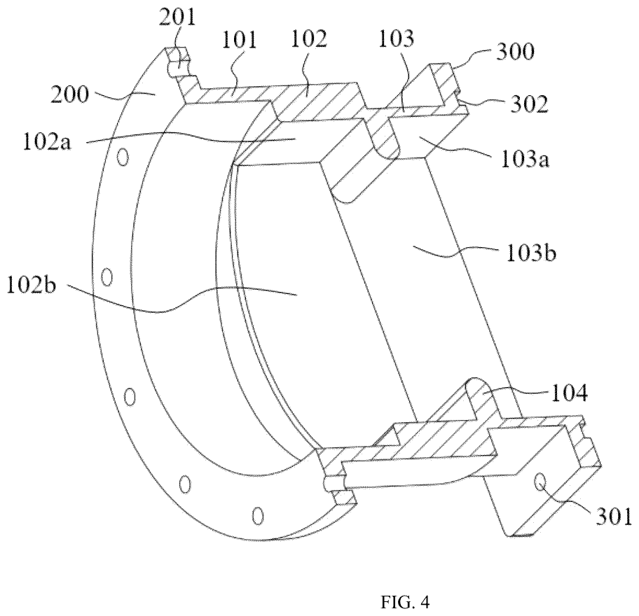

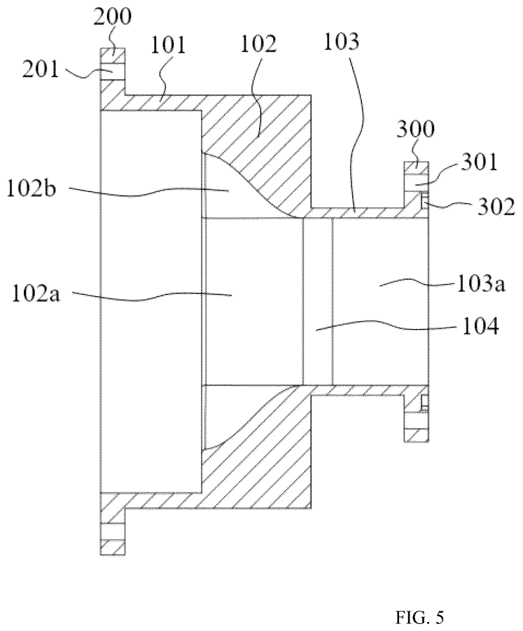

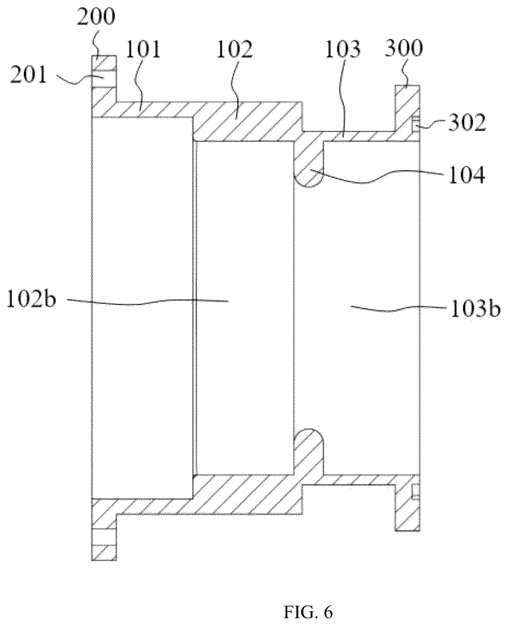

The circular waveguide (101) is connected coaxially to the rectangular waveguide (103) through the transition waveguide (102). Each of the three waveguide sections (101, 102, 103) has a length not exceeding ¼λ_{g}, making the total converter length no greater than ¾λ_{g}. As shown in FIGS. 4 and 5, the cross-section of the transition waveguide (102) at the junction with the circular waveguide (101) is elliptical and flattened at both opposite sides by two planes (102a). The height between these planes equals the height (103a) of the rectangular waveguide (103), and the planes (102a) are aligned with the corresponding planes (103a). In FIGS. 5 and 6, the curved elliptical surfaces (102b) of the transition waveguide are gradually flattened so that the inner surfaces of (102) and (103) coincide smoothly at their junction.

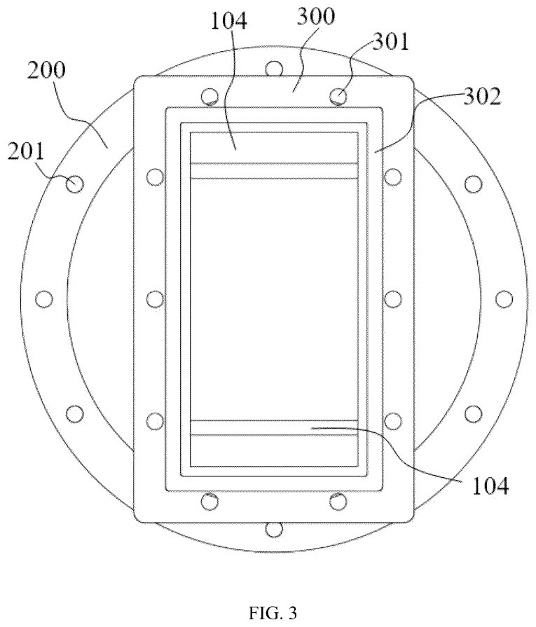

The circular-to-rectangular waveguide transition has two flanges: a circular flange (200) and a rectangular flange (300). The circular flange (200) is located at the end of the circular waveguide opposite the transition section and contains twelve bolt holes (201) (see FIGS. 2 and 4). The rectangular flange (300) is located at the end of the rectangular waveguide opposite the transition section and includes ten bolt holes (301) and a groove (302) for an airtight sealing gasket (FIGS. 3 and 4).

Referring to FIGS. 4-6 , two impedance-matching iris bars (104) are symmetrically placed inside the rectangular waveguide (103), perpendicular to the long surface (103b) of the rectangular waveguide. As shown in FIG. 5, the height of each iris equals the internal width of the rectangular waveguide. As shown in FIG. 6, each iris has a semicylindrical cross-section, in which one face contacts the flat wall (103a) and the other coincides with the junction plane between (102) and (103).

By forming semicylindrical surfaces facing the interior, the two iris bars effectively match the impedance between the circular and rectangular waveguides, eliminating the need for a long gradual transition as in conventional circular-to-rectangular waveguide transition.

All components—circular flange (200), rectangular flange (300), circular waveguide (101), transition waveguide (102), rectangular waveguide (103), and iris bars (104) may be made from standard waveguide materials such as aluminum, stainless steel (SUS 304/316), or brass.

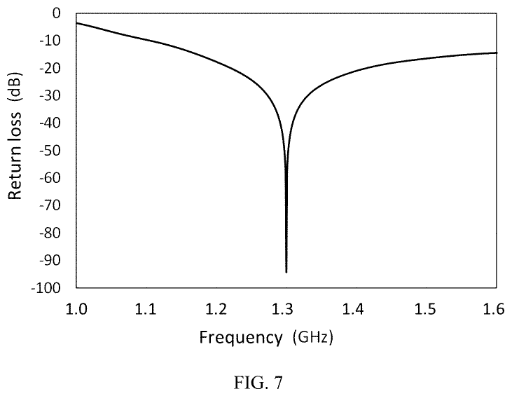

FIG. 7 shows the measured return loss of the circular-to-rectangular waveguide transition operating in the L-band with a center frequency of 1.3 GHz. The return loss remains lower than 15 dB across a 200 MHz bandwidth, corresponding to less than 3% reflected power. At the center frequency of 1.3 GHz, the return loss reaches 95 dB, indicating nearly zero reflection within the transition.

What is claimed is:

1. A high-power circular-to-rectangular waveguide transition comprising:
a circular waveguide having a length not exceeding ¼λ_{g};
a rectangular waveguide having a length not exceeding ¼λ_{g};
a transition waveguide coaxially connecting the circular and rectangular waveguides, the transition waveguide having a length not exceeding ¼λ_{g}, a circular-elliptical cross-section at one end connected to the circular waveguide, and a rectangular cross-section at the other end connected to the rectangular waveguide, wherein the inner surface of the transition waveguide is gradually flattened so as to match the plane of the rectangular waveguide at the contact interface;
a circular flange with twelve bolt holes arranged at the end of the circular waveguide opposite the transition section;
a rectangular flange with ten bolt holes and an airtight gasket groove arranged at the end of the rectangular waveguide opposite the transition section;
two impedance-matching iris bars located within the rectangular waveguide, perpendicular to a broad wall of the rectangular waveguide, each iris having a cross-section with a semicylindrical inner surface facing an interior of the waveguide and a rectangular outer portion having one surface in contact with the broad wall and another coinciding with the junction plane between the transition and rectangular waveguides.
